(19) United States
(12) Patent Application Publication
(10) Pub. No.: US 2009/0063998 A1
(43) Pub. Date: Mar. 5, 2009

(54) METHOD, SYSTEM, AND PROGRAM PRODUCT FOR COLLABORATIVE DIAGRAM EDITING

(76) Inventors: Jinchao Huang, Markham (CA); Michael Starkey, Vancouver (CA)

Correspondence Address: HOFFMAN WARNICK LLC, 75 STATE ST, 14TH FLOOR, ALBANY, NY, 12207, US

(21) Appl. No.: 11/850,081

(22) Filed: Sep. 5, 2007

(51) Int. Cl. G06F 3/048

(52) U.S. Cl. 715/760

(57) ABSTRACT

The invention provides a method, system, and program product for collaboratively editing a diagram.

### TECHNICAL FIELD

The invention relates generally to collaborative editing and, more particularly, to the collaborative browser-based editing of a diagram.

### BACKGROUND OF THE INVENTION

The Internet has largely removed the time and location constraints of group communication. Multiple individuals now have the ability to collaboratively create or edit documents online through web applications such as Wiki. However, such creation and editing is limited to text, graphical items generally being non-updateable without the installation of graphical editing/rendering software on the computer systems of each user. Installing such software on each user's computer system is both expensive and time-consuming. In addition, one must know in advance who will be involved in the collaborative creation or editing so that the graphical editing/rendering software may be installed. This frustrates the benefits of online collaborative work, which is often spontaneous and/or open to a large number of potential participants.

Accordingly, there exists a need in the art to overcome the deficiencies and limitations described hereinabove.

### SUMMARY OF THE INVENTION

The invention provides a method, system, and program product for collaboratively editing a diagram.

A first aspect of the invention provides a method of editing a diagram comprising: creating an image file and an extensible markup language (XML) file describing a diagram's contents based on a diagram; providing access to the image file and XML file to at least one user; accessing the image file and the XML file using a web browser; editing the XML file using the web browser; and updating the diagram based on the edited XML file.

A second aspect of the invention provides a system for collaboratively editing a diagram, the system comprising: a system for creating an image file and an extensible markup language (XML) file describing a diagram's contents based on a diagram; a system for providing access to the image file and XML file to at least one user; a system for accessing the image file and the XML file using a web browser; a system for editing the XML file using the web browser; and a system for updating the diagram based on the edited XML file.

A third aspect of the invention provides a program product stored on a computer-readable medium, which when executed, facilitates collaborative editing of a diagram, the program product comprising: program code for creating an image file and an extensible markup language (XML) file describing a diagram's contents based on a diagram; program code for providing access to the image file and XML file to at least one user; program code for accessing the image file and the XML file using a web browser; program code for editing the XML file using the web browser; and program code for updating the diagram based on the edited XML file.

A fourth aspect of the invention provides a method for deploying an application for collaboratively editing a diagram, comprising: providing a computer infrastructure being operable to: create an image file and an extensible markup language (XML) file describing a diagram's contents based on a diagram; provide access to the image file and XML file to at least one user; access the image file and the XML file using a web browser; edit the XML file using the web browser; and update the diagram based on the edited XML file.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative diagram that may be collaboratively edited according to the invention.

FIG. 2 shows an illustrative image file based on the diagram of FIG. 1 and created according to an embodiment of the invention.

FIG. 3 shows an illustrative extensible markup language (XML) file describing the image file of FIG. 2.

FIG. 4 shows an edited version of the image file of FIG. 2.

FIG. 5 shows an edited version of the XML file of FIG. 3.

FIG. 6 shows an updated diagram based on the edited image file of FIG. 4 and the edited XML file of FIG. 5.

FIG. 7 shows a flow diagram of an illustrative method according to the invention.

FIG. 8 shows an illustrative system according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

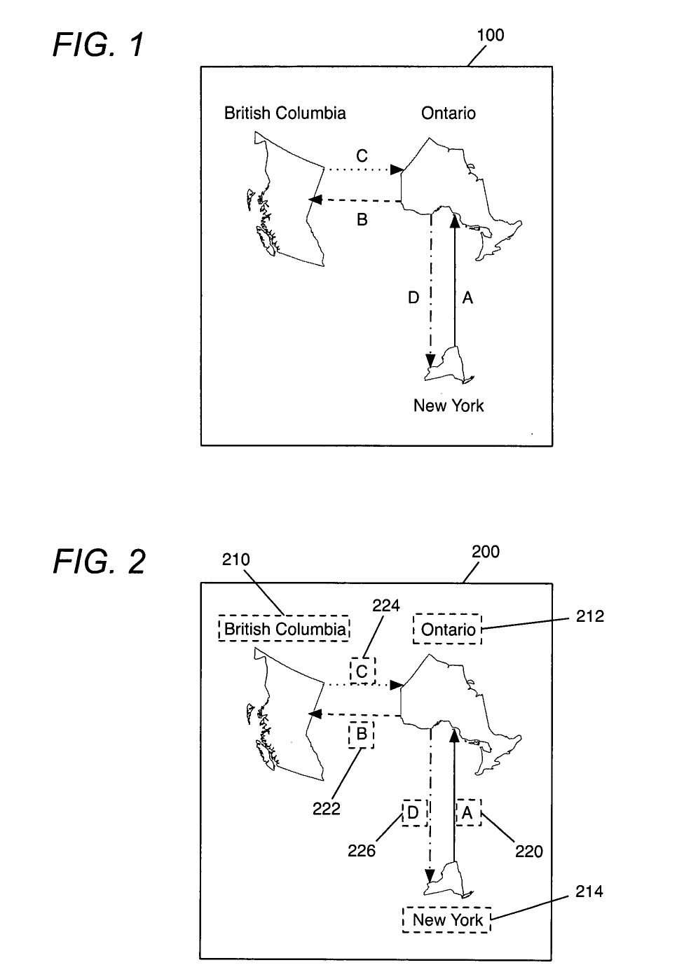

Referring now to the drawings, FIG. 1 shows an illustrative diagram 100 that may be collaboratively edited according to an embodiment of the invention. For purposes of aiding in the description of the invention below, diagram 100 can be viewed as showing a flow of information from New York to Ontario to British Columbia and then back to Ontario and New York.

FIG. 2 shows an image 200 created from diagram 100 (FIG. 1). Image 200 may have any number of formats. Commonly-employed image formats (and their common file extensions) include, for example, graphic interchange format (.gif), the Joint Photographic Experts Group 24 bit compressed format (.jpg), bitmap (.bmp), tagged image file format (.tiff or .tif), portable network graphic (.png), and scalable vector graphic (.svg). Other image formats may also be employed in practicing the invention and are, therefore, within the scope of the invention.

As can be seen in FIG. 2, a number of updateable areas 210-226 have been designated within image 200. As will be explained in greater detail below, updateable areas 210-226 may be edited or otherwise modified by a user via the user's web browser. Thus, image 200 may be collaboratively edited by any number of users without each user needing a graphical editing software program.

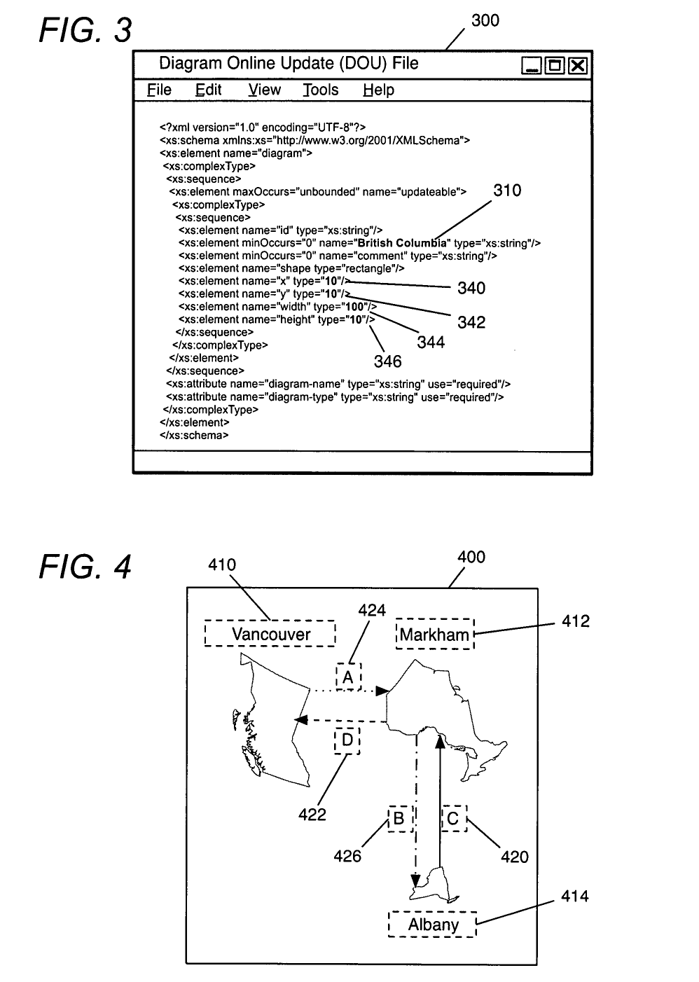

FIG. 3 shows an illustrative extensible markup language (XML) file 300 describing the contents of image 200, including updateable areas 210-226. For example, name 310 (“British Columbia”) describes updateable area 210, X- and Y-coordinates 340, 342 describe the relative position of updateable area 210 within image 200, and width 344 and height 346 describe the dimensions of updateable area 210 with respect to X- and Y-coordinates 340, 342. Thus, XML file 300 describes the areas of image 200 that may be updated by a user via the user's web browser.

FIG. 4 shows edited image 400, in which a user has edited each of the updateable areas. More particularly, “British Columbia” has been edited to read “Vancouver,” “Ontario” has been edited to read “Markham,” and “New York” has been edited to read “Albany.” In addition, each of editable areas 220-226 (FIG. 2) has been edited, such that the flow of information has been reversed from that shown in FIG. 2 (i.e., information now flows from Vancouver to Markham to Albany and then back to Markham and Vancouver).

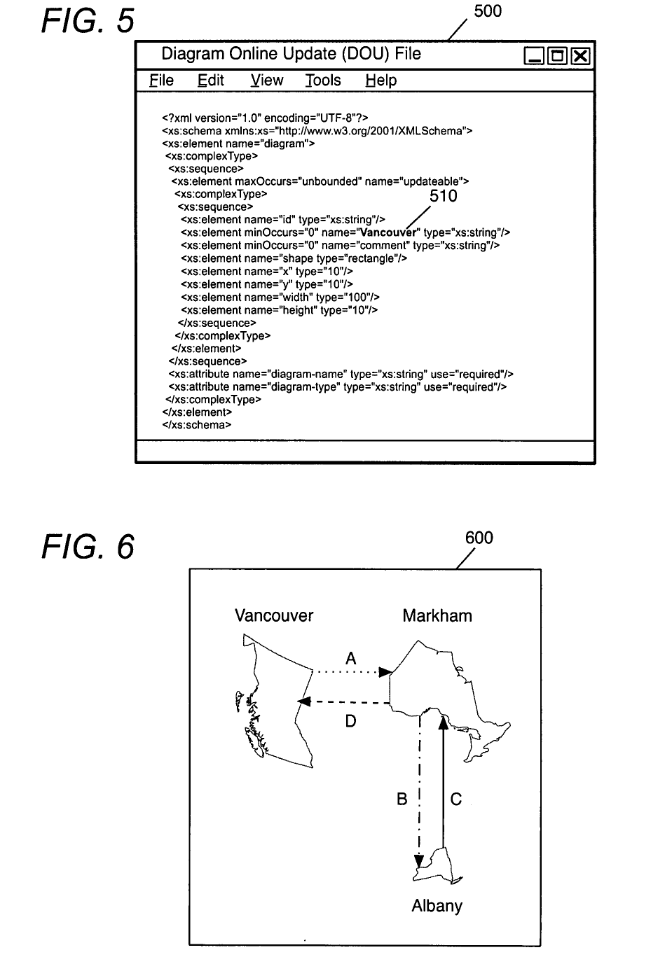

The edits shown in edited image 400 are made in the underlying XML file 300 (FIG. 3). For example, FIG. 5 shows an edited XML file 500, wherein name 510 has been edited to “Vancouver” from name 310 (“British Columbia”) in FIG. 3. Edits to the XML file 300 are preferably made without direct editing of the XML file by a user. For example, the user's web browser is preferably capable of editing the XML file 300 as edits are made to image 200 (FIG. 2). Alternatively, a user with XML coding experience may directly edit XML file 300.

In either case, edited XML file 500 may then be used to create an updated diagram 600, such as that shown in FIG. 6. To do so, the edited XML file 500 is transferred to a computer system and/or server application with which diagram 100 (FIG. 1) was first prepared (or to a similarly-equipped computer system and/or server application) and the updated diagram 600 is prepared, reflecting edits to the edited XML file 500. In one embodiment, the graphical editing and/or rendering software used to prepare diagram 100 is a server-based program. Thus, the server-based program may be called upon to prepare updated diagram 600 from the edited XML file 500 by calling the application programming interface (API) of the server-based program.

Once the updated diagram 600 is prepared, the steps above may be iterated (i.e., an image file and XML file may be created based on the updated diagram 600, the image file and XML file may be provided to one or more users who then access and edit the XML file, which is then transferred back to a graphical editing and/or rendering program with which yet another updated diagram is prepared, etc.).

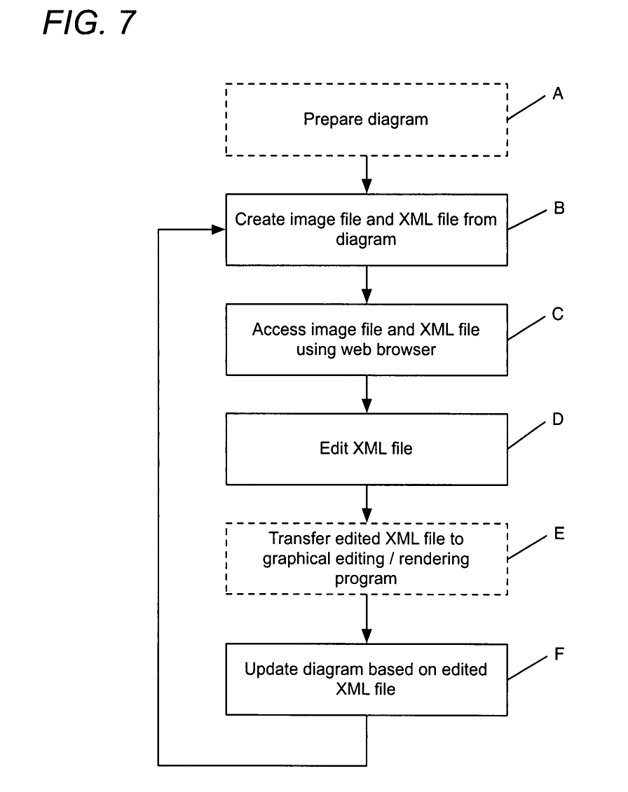

FIG. 7 shows a flow diagram of an illustrative method according to the invention. At A, a diagram is optionally prepared using a graphical editing/rendering program. At B, an image file and XML file are created based on a diagram (the diagram prepared at A or a diagram otherwise selected). A user then accesses the image file and XML file at C and edits the XML file at D using his or her web browser. As noted above, a user may manipulate the image file within the web browser, but it is the underlying XML file that is edited, even if the XML file is not visible to or directly manipulable by the user. At E, the edited XML file is optionally transferred to a graphical editing/rendering program. Such transfer is optional, since both the edited XML file and graphical editing/rendering program may, in some instances, be stored in the same computer system. At F, the diagram is updated based on the edited XML file. Steps B through F may be iteratively looped, with edits from a number of users or multiple edits from the same user each yielding an edited XML file and updated diagram.

Because all edits are made to the underlying XML file, users may employ different computer operating systems and/or different web browsers in making their edits. Similarly, since diagrams are converted to an image and XML file before being provided to users for editing, the invention does not require any particular graphical editing software. Any diagram prepared using any graphical editing and/or rendering software may be used to create an image file and XML file as described above.

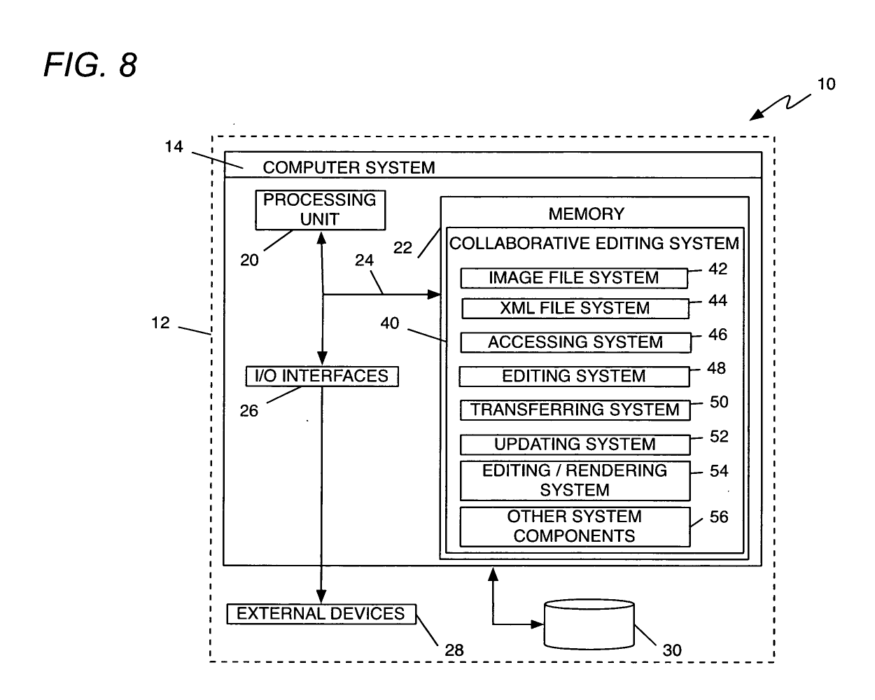

FIG. 8 shows an illustrative system 10 for collaboratively editing a diagram. To this extent, system 10 includes a computer infrastructure 12 that can perform the various process steps described herein for collaboratively editing a diagram. In particular, computer infrastructure 12 is shown including a computer system 14 that comprises a collaborative editing system 40, which enables computer system 14 to facilitate collaborative editing of a diagram by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as collaborative editing system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and collaborative editing system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, collaborative editing system 40 enables computer system 14 to facilitate collaborative editing of a diagram. To this extent, collaborative editing system 40 is shown including an image file system 42, an XML file system 44, an accessing system 46, an editing system 48, a transferring system 50, an updating system 52, and a graphical editing/rendering system 54. Operation of each of these systems is discussed above. Collaborative editing system 40 may further include other system components 56 to provide additional or improved functionality to collaborative editing system 40. It is understood that some of the various systems shown in FIG. 8 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for collaboratively editing a diagram, it is understood that the invention further provides various alternative embodiments. For example, in one embodiment, the invention provides a computer-readable medium that includes computer program code to enable a computer infrastructure to facilitate collaborative editing of a diagram. To this extent, the computer-readable medium includes program code, such as collaborative editing system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to facilitate collaborative editing of a diagram as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for facilitating collaborative editing of a diagram. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of editing a diagram comprising:
creating an image file and an extensible markup language (XML) file describing a diagram's contents based on a diagram;
providing access to the image file and XML file to at least one user;
accessing the image file and the XML file using a web browser;
editing the XML file using the web browser; and
updating the diagram based on the edited XML file.

2. The method of claim 1, further comprising:
transferring the edited XML file to a graphical editing program.

3. The method of claim 2, further comprising:
preparing the diagram using the graphical editing program.

4. The method of claim 2, wherein the graphical editing program is a server-based program.

5. The method of claim 1, further comprising:
defining at least one updateable area in at least one of the image file and the XML file.

6. The method of claim 5, wherein editing the XML file includes editing the at least one updateable area in the XML file.

7. The method of claim 1, further comprising:
recreating an image file and an XML file based on the updated diagram; and
providing access to the recreated image file and XML file.

8. A system for collaboratively editing a diagram, the system comprising:
a system for creating an image file and an extensible markup language (XML) file describing a diagram's contents based on a diagram;
a system for providing access to the image file and XML file to at least one user;
a system for accessing the image file and the XML file using a web browser;
a system for editing the XML file using the web browser; and
a system for updating the diagram based on the edited XML file.

9. The system of claim 8, further comprising:
a system for transferring the edited XML file to a graphical editing program.

10. The system of claim 9, further comprising:
a system for preparing the diagram using the graphical editing program.

11. The system of claim 9, wherein the graphical editing program is a server-based program.

12. The system of claim 8, further comprising:
a system for defining at least one updateable area in at least one of the image file and the XML file.

13. The system of claim 12, wherein the system for editing the XML file includes a system for editing the at least one updateable area in the XML file.

14. The method of claim 8, further comprising:
a system for recreating an image file and an XML file based on the updated diagram; and
a system for providing access to the recreated image file and XML file.

15. A program product stored on a computer-readable medium, which when executed, facilitates collaborative editing of a diagram, the program product comprising:
program code for creating an image file and an extensible markup language (XML) file describing a diagram's contents based on a diagram;
program code for providing access to the image file and XML file to at least one user;
program code for accessing the image file and the XML file using a web browser;
program code for editing the XML file using the web browser; and
program code for updating the diagram based on the edited XML file.

16. The program product of claim 15, further comprising:
program code for transferring the edited XML file to a graphical editing program.

17. The program product of claim 15, further comprising:
program code for preparing the diagram using the graphical editing program.

18. The program product of claim 15, further comprising:
program code for defining at least one updateable area in at least one of the image file and the XML file.

19. The program product of claim 15, further comprising:
program code for recreating an image file and an XML file based on the updated diagram; and
program code for providing access to the recreated image file and XML file.

20. A method for deploying an application for collaboratively editing a diagram, comprising:
providing a computer infrastructure being operable to:
create an image file and an extensible markup language (XML) file describing a diagram's contents based on a diagram;
provide access to the image file and XML file to at least one user;
access the image file and the XML file using a web browser;
edit the XML file using the web browser; and
update the diagram based on the edited XML file.
